(19) United States
(12) Patent Application Publication
(10) Pub. No.: US 2016/0101481 A1
(43) Pub. Date: Apr. 14, 2016

(54) SYSTEM AND METHOD FOR MONITORING WELDING THRESHOLD CONDITIONS

(71) Applicant: ILLINOIS TOOL WORKS INC., Glenview, IL (US)

(72) Inventors: Todd Earl Holverson, Appleton, WI (US); Christopher J. Nelli, Schaumburg, IL (US)

(21) Appl. No.: 14/513,752

(22) Filed: Oct. 14, 2014

(51) Int. Cl. B23K 9/095; B23K 7/00; B23K 20/12; B23K 9/10; B23K 9/16

(52) U.S. Cl. CPC B23K 9/0956; B23K 9/10; B23K 9/16; B23K 20/123; B23K 7/00

(57) ABSTRACT

A metal fabrication system includes one or more sensors configured to transmit a first signal relating to a first condition of an environment of the metal fabrication system, processing circuitry coupled to the one or more sensors, and a feedback device coupled to the processing circuitry. The processing circuitry is configured to determine the first condition of the environment based at least in part on the first signal and to compare the first condition to a first threshold. The feedback device is configured to provide a first notification when the first condition satisfies the first threshold.

### BACKGROUND

The invention relates generally to monitoring threshold conditions and, more particularly, to systems and methods for monitoring threshold conditions of a welding system.

Metal fabrication is a process that has increasingly become utilized in various industries and applications. For example, metal fabrication may include welding, cutting, forming, and the like. Such processes may be automated in certain contexts, although a large number of applications continue to exist for manual welding operations. In both cases, the conditions of the environment about a welding system may affect characteristics of the weld. Some welding processes are to be performed only under specified environmental conditions, such as may be specified in a welding procedure specification (WPS). The environmental conditions may change with time. Waiting for conditions to change and unknowingly waiting longer than necessary may increase costs associated with the process.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a metal fabrication system includes one or more sensors configured to transmit a first signal relating to a first condition of an environment of the metal fabrication system, processing circuitry coupled to the one or more sensors, and a feedback device coupled to the processing circuitry. The processing circuitry is configured to determine the first condition of the environment based at least in part on the first signal and to compare the first condition to a first threshold. The feedback device is configured to provide a first notification when the first condition satisfies the first threshold.

In another embodiment, a method includes of operating a metal fabrication system includes receiving, using processing circuitry, a first signal relating to a first condition of an environment of the metal fabrication system, determining, using the processing circuitry, the first condition of the environment based at least in part on the first signal, comparing, using the processing circuitry, the first condition to a first threshold and providing, using a feedback device, a first notification when the first condition satisfies the first threshold.

In another embodiment, a welding monitoring system includes one or more temperature sensors configured to determine a first temperature of a work piece of the welding system, processing circuitry configured to compare the first temperature to a first temperature threshold, and a feedback device configured to provide a first notification to an operator of the welding system when the first temperature satisfies the first temperature threshold. The first notification includes a visual feedback, an audible feedback, a haptic feedback, or any combination thereof.

### DRAWINGS

These and other features, aspects, and advantages of the present invention will become better understood when the following detailed description is read with reference to the accompanying drawings in which like characters represent like parts throughout the drawings, wherein:

FIG. 1 is an illustration of an embodiment of a welding system with a monitoring system;

FIG. 2 is an illustration of an embodiment of the monitoring system and a welding environment;

FIG. 3 is a chart of an embodiment of temperature with respect to time of a workpiece during a multi-pass welding process;

FIG. 4 is a chart of an embodiment of temperature with respect to time of a workpiece during a welding process;

FIG. 5 is a chart of an embodiment of oxygen concentration with respect to time of a welding environment; and

FIG. 6 is a flow chart of an embodiment of a process for determining a condition of an environment about the welding system.

### DETAILED DESCRIPTION

One or more specific embodiments of the present disclosure will be described below. These described embodiments are only examples of the present disclosure. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The conditions of a metal fabrication (e.g., welding) environment may change over time. An operator may actively change some environmental conditions, such as heating a work piece, cooling a work piece, or displacing gas proximate to a weld. Additionally, or in the alternative, some environmental conditions may change without direct action by the welding operator, such as passive cooling between welding passes. The welding operator may perform a welding process when one or more environmental conditions (e.g., work piece temperature, gas concentration proximate to the weld) satisfy corresponding thresholds, and the welding operator may refrain from performing a welding process when the one or more environmental conditions do not satisfy the corresponding thresholds. The thresholds for performing a welding process may be based at least in part on various factors including, but not limited, to a welding procedure specification (WPS), the material of the work piece, an experience level of the welding operator, or any combination thereof. Embodiments of the welding system as described herein may determine when one or more environmental conditions satisfy the corresponding thresholds. The welding system may provide a notification via a monitoring system when the one or more environmental conditions satisfy the corresponding thresholds. Additionally, or in the alternative, the welding system may record via the monitoring system when the one or more environmental conditions satisfy the corresponding thresholds. The welding system may provide the notification to one or more recipients, such as the welding operator, a supervisor, a network coupled to the welding system, or any combination thereof. In some embodiments, the notification facilitates efficient utilization of the welding system by one or more welding operators. Additionally, or in the alternative, the notification enables the welding operator to reduce a wait time between welding processes. Moreover, in some embodiments, the monitoring system may interrupt the continuation of a process or prevent a process from starting when environmental conditions are outside of a desired operating range defined by one or more thresholds. Accordingly, the monitoring system may enable four or more modes of operation, including but not limited to only recording one or more environmental conditions, providing a notification when one or more environmental conditions satisfy corresponding thresholds (e.g., are within a desired operating range), preventing the initiation of a process when one or more environmental conditions do not satisfy corresponding thresholds, and stopping or halting an active process when one or more environmental conditions do not satisfy corresponding thresholds. In some embodiments, the monitoring system may enable the continuation or initiation of a process despite one or more environmental conditions not satisfying corresponding thresholds upon acknowledgement of the unsatisfied conditions by the operator or a supervisor.

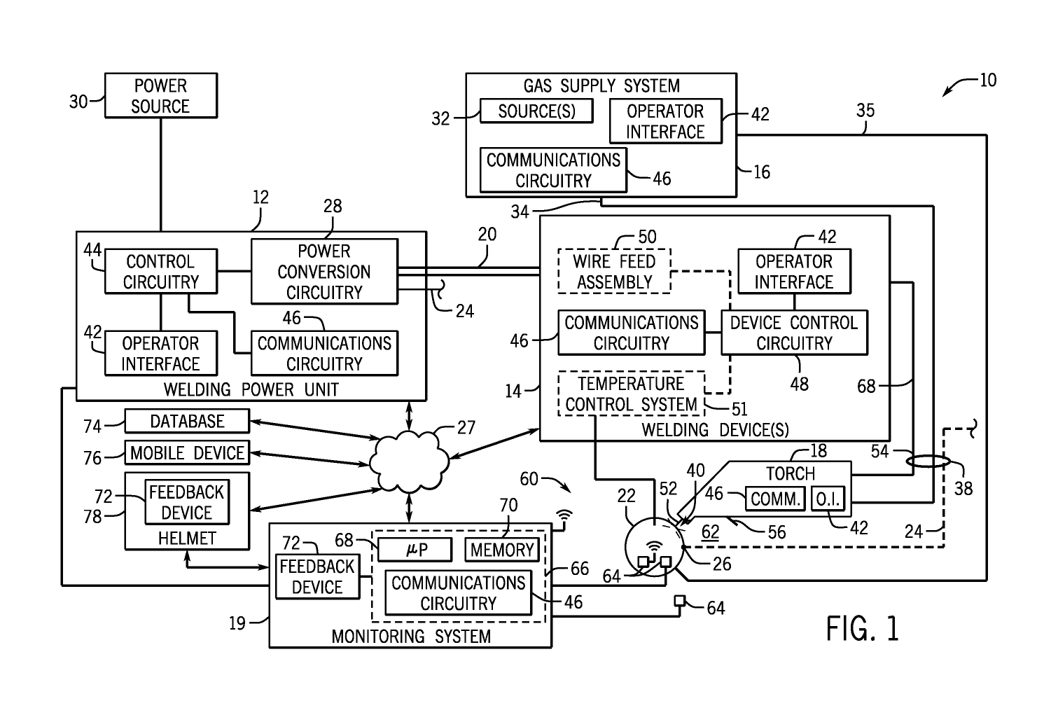

Turning to the figures, FIG. 1 illustrates an embodiment of a metal fabrication system 10 (e.g., a gas metal arc welding (GMAW) system) where a welding power unit 12 and one or more welding devices 14 may be utilized together in accordance with aspects of the present disclosure. It should be appreciated that, while the present discussion may focus specifically on the GMAW system 10 illustrated in FIG. 1, the presently disclosed methods may be used in metal fabrication systems using any arc welding process (e.g., FCAW, FCAW-G, GTAW (i.e., TIG), SAW, SMAW, plasma welding, laser welding, friction stir welding, hybrid welding process that is a combination of two or more welding processes), cutting process (e.g., plasma, oxygen, hybrid cutting that is a combination of two or more cutting processes), heating process (e.g., induction, flame), forming process, and any similar process.

As illustrated, the welding system 10 includes the welding power unit 12, the welding device 14 (e.g., a welding wire feeder, remote device, pendant, remote control, welding sensor), a gas supply system 16, a welding torch 18, and a monitoring system 19. The welding power unit 12 generally supplies welding power (e.g., voltage, current, etc.) for the welding system 10, and the welding power unit 12 may be coupled to the welding device 14 via a cable bundle 20, and the welding power unit 12 may be coupled to a work piece 22 using a work cable 24 having a clamp 26. The work cable 24 may be integrated with or separate from the cable bundle 20. In some embodiments, the work cable 24 couples the work piece 22 to the welding power unit 12 via the welding device 14, as shown by the dashed work cable 24.

Communications circuitry 46 elements of the welding system 10 may communicate with each other via wired or wireless communications. For example, communications circuitry 46 of the welding power unit 12 may communicate with communications circuitry 46 of the welding device 14, the gas supply 16, the monitoring system 19, or any combination thereof. In some embodiments, the cable bundle 20 includes a wired communication line between the welding power unit 12 and the welding device 14. Furthermore, the welding power unit 12 may communicate with the welding device 14 via power line communication where data is provided (e.g., transmitted, sent, transferred, delivered) over welding power (e.g., over the same physical electrical conductor). As will be appreciated, the welding power unit 12 may communicate (e.g., receive and/or transmit signals) with the welding device 14 using any suitable wired protocol (e.g., RS-232, RS-485, Ethernet, a proprietary communication protocol, and so forth) or wireless protocol (e.g., Wi-Fi, Bluetooth, Zigbee, cellular, and so forth). In certain embodiments, the welding power unit 12 and the welding device 14 may communicate using a wired communication line that links the welding power unit 12 and the welding device 14. Additionally, or in the alternative, communications circuitry 46 elements of the welding system 10 may communicate with each other via a network 27 (e.g., Internet, intranet, cloud, and so forth). Accordingly, the welding power unit 12 may communicate with the welding device 14 via the Internet. In some embodiments, the welding power unit 12 and the welding device 14 may communicate (e.g., either directly, or indirectly via the network 27) using a wireless communication channel (e.g., Wi-Fi, Bluetooth, Zigbee, cellular). For example, a cellular wireless communications channel may communicate via standards including, but not limited to, the code division multiple access (CDMA) standard, the Global System for Mobile Communications (GSM) standard, or any combination thereof.

The welding power unit 12 may include power conversion circuitry 28 that receives input power from a power source 30 (e.g., an AC power grid, an engine/generator set, a battery, or a combination thereof), conditions the input power, and provides DC or AC output power via the cable bundle 20. As such, the welding power unit 12 may power the welding device 14 that, in turn, powers the welding torch 18, in accordance with demands of the welding system 10. Moreover, the welding power unit 12 may power the gas supply system 16 and/or the monitoring system 19. The work cable 24 terminating in the clamp 26 couples the welding power unit 12 to the work piece 22 to close the circuit between the welding power unit 12, the work piece 22, and the welding torch 18. The power conversion circuitry 28 may include circuit elements (e.g., transformers, rectifiers, switches, boost converters, buck converters, and so forth) capable of converting an AC input power to a direct current electrode positive (DCEP) output, direct current electrode negative (DCEN) output, DC variable polarity, pulsed DC, or a variable balance (e.g., balanced or unbalanced) AC output, as dictated by the demands of the welding system 10.

The illustrated welding system 10 includes the gas supply system 16 that supplies a shielding gas or shielding gas mixtures from one or more shielding gas sources 32 to the welding torch 18. The gas supply system 16 may be directly coupled to the welding power unit 12, the welding device 14, and/or the welding torch 18 via a gas line 34. A gas control system 36 having one or more valves respectively coupled to the one or more shielding gas sources 32 may regulate the flow of gas from the gas supply system 16 to the welding torch 18. The gas control system 36 may be integrated with the welding power unit 12, the welding device 14, the gas supply system 16, or any combination thereof.

A shielding gas, as used herein, may refer to any gas or mixture of gases that may be provided to an arc 40 and/or the weld pool in order to provide a particular local atmosphere (e.g., to shield the arc, improve arc stability, limit the formation of metal oxides, improve wetting of the metal surfaces, alter the chemistry of the weld deposit relative to the filler metal and/or base metal, and so forth). In general, the shielding gas is provided at the time of welding, and may be turned on preceding the weld and/or following the weld. In certain embodiments, the shielding gas flow may be a shielding gas or shielding gas mixture (e.g., argon (Ar), helium (He), carbon dioxide (CO₂), similar suitable shielding gases, or any mixtures thereof). For example, a shielding gas flow (e.g., delivered via gas line 34) may include Ar, Ar/CO₂ mixtures, Ar/CO₂/O₂ mixtures, Ar/He mixtures, and so forth. The gas supply system 16 may supply a secondary shielding gas flow (e.g., purge flow) to the work piece 22 via a second gas line 35. For example, the gas supply system 16 may provide the secondary shielding gas flow to a back side or interior of the work piece 22 to control the environment at the back side of the work piece 22.

In the illustrated embodiment, the welding device 14 is coupled to the welding torch 18 via a cable bundle 38 in order to supply consumables (e.g., shielding gas, welding wire, and so forth) and welding power to the welding torch 18 during operation of the welding system 10. In another embodiment, the cable bundle 38 may only provide welding power to the welding torch 18. During operation, the welding torch 18 may be brought near the work piece 22 so that the arc 40 may be formed between the welding electrode (e.g., the welding wire exiting a contact tip of the welding torch 18) and the work piece 22.

One or more operator interfaces 42 of the welding system 10 facilitate the input of settings (e.g., weld parameters, weld process, and so forth) by the operator, and may facilitate the output or display of information to the operator. As may be appreciated, one or more the components of the welding system 10 may have a respective operator interface 42. For example, the operator interface 42 of the welding power unit 12 may be incorporated into a front faceplate of the welding power unit 12 to allow for operator selection of settings. The selected settings are communicated to control circuitry 44 within the welding power unit 12. The control circuitry 44, described in greater detail below, operates to control generation of welding power output from the welding power unit 12 that is applied to the electrode by the power conversion circuitry 28 for carrying out the desired welding operation. The control circuitry 44 may control the power conversion circuitry 28 based at least in part on settings received via the operator interface 42, settings received via communications circuitry 46 of the welding power unit 12, thresholds monitored by the monitoring system 19, thresholds monitored by the temperature control system 51, or any combination thereof.

Device control circuitry 48 of the one or more welding devices 14 may control various components of the respective welding device 14. In some embodiments, the device control circuitry 48 may receive input from an operator interface 42 of the welding device 14 and/or input from the communications circuitry 46 of the welding device 14. In certain embodiments, the one or more welding devices 14 may include a wire feeder having a wire feed assembly 50 controlled by the device control circuitry 48. The wire feed assembly 50 may include, but is not limited to, a motor, drive wheels, a spool, power conversion circuitry, or any combination thereof. In some embodiments, the operator interface 42 of the welding device 14 may enable the operator to select one or more weld parameters, such as wire feed speed, the type of wire utilized, the current, the voltage, the power settings, and so forth.

In certain embodiments, the welding device 14 may include a temperature control system 51 that heats or cools the work piece 22. For example, the temperature control system 51 may include an induction coil, a flame, or a resistance heater to warm the work piece 22, such as to pre-heat or post-heat the work piece 22. Moreover, the temperature control system 51 may cool the work piece 22 via a heat exchanger, a fan, or any combination thereof. As may be appreciated, the microstructure of the work piece 22 and the weld material may be based at least in part on the temperature of the work piece 22 at the beginning of a weld process, total heat input to the work piece 22, the cooling rate of the work piece 22, or any combination thereof.

Power from the welding power unit 12 is applied to an electrode 52 (e.g., welding wire) to form the arc 40. The power is typically applied via a weld cable 54 of the cable bundle 38 coupled to the welding torch 18. Similarly, shielding gas may be fed through the cable bundle 38 to the welding torch 18 via the gas line 34. In some embodiments, the wire 52 is advanced through the cable bundle 38 towards the welding torch 18 during welding operations. A trigger switch 56 may initiate gas flow and advance the powered electrode 52 toward the work piece 22 to form the arc 40.

The monitoring system 19 is configured to monitor conditions of an environment 60 about the work piece 22. As discussed herein, the environment 60 includes, but is not limited to, the work piece 22, the welding torch 18, and the surroundings 62 thereof proximate to the work piece 22 and/or the welding torch 18. One or more sensors 64 coupled to the monitoring system 19 are configured to transmit signals to the monitoring system 19 relating to the conditions of the environment 60. The conditions of the environment 60 monitored by the monitoring system 19 do not include the weld current or weld voltage provided by the welding power unit 12 to the welding torch 18. In some embodiments, sensors 64 may be coupled directly or indirectly to the work piece 22. Additionally, or in the alternative, sensors 64 may be disposed in the environment 60 about the work piece 22. For example, temperature sensors may transmit signals to the monitoring system 19 related to a temperature of the work piece 22. Temperature sensors may include, but are not limited to, thermocouples, resistance temperature detectors (RTDs), infrared sensors, and/or thermistors. Additionally, or in the alternative, gas sensors may transmit signals to the monitoring system 19 related to a composition of gases in the surroundings 62 about the work piece 22. Gas sensors may include, but are not limited to, electrochemical sensors, lambda sensors, infrared sensors, or semiconductor sensors. The sensors 64 may monitor the environment 60 prior to, during, and after performing a welding operation. The sensors 64 may be coupled to the monitoring system 19 via a wired or wireless connection.

The sensors 64 transmit signals to processing circuitry 66 of the monitoring system 19, and the processing circuitry 66 determines the environmental conditions related to the received signals. For example, a processor 68 of the processing circuitry 66 may execute instructions stored in a memory 70 of the processing circuitry 66 to determine the environmental conditions from the received signals. The memory 70 may store one or more thresholds for respective environmental conditions, thereby enabling the processing circuitry 66 to compare the determined environmental conditions to the one or more respective thresholds. The one or more thresholds for each environmental condition may be input into the memory 70 by the operator, loaded into the memory 70 during assembly of the monitoring system 19, loaded into the memory 70 via the network 27, or any combination thereof. For example, the communications circuitry 46 of the components of the welding system 10 may enable one or more thresholds received via an operator interface 42 of any of the components of the welding system 10 to be stored in the memory 70. While the processing circuitry 66 is illustrated in FIG. 1 as disposed within a monitoring system component 19 of the metal fabrication system 10 (e.g., welding system), the processing circuitry 66 may be disposed within a mobile device 76 coupled to the monitoring system 19, a remote or local computer coupled to the monitoring system 19, or another component (e.g., welding power unit 12, welding device 14) of the metal fabrication system 10, or any combination thereof. Additionally, or in the alternative, the processing circuitry 66 may be a part of the network 27, thereby enabling the network (e.g., cloud) to determine the environmental conditions related to the received signals and/or to compare determined environmental conditions to respective thresholds.

A feedback device 72 coupled to the processing circuitry 66 provides a notification to one or more recipients (e.g., operator, administrator, network 27, and so forth) when an environmental condition satisfies a respective threshold. For example, the feedback device 72 may notify the operator when the work piece 22 is cooled below a first threshold temperature, when the work piece 22 is preheated above a second threshold temperature, when an oxygen concentration of the environment 62 is less than a first threshold concentration, when a humidity of the environment 62 is less than a second threshold concentration, or any combination thereof. The notification provided by the feedback device 72 may be visual feedback (e.g., light, text, and so forth), audible feedback (e.g., tone), haptic feedback (e.g., vibration), or any combination thereof. In some embodiments, the monitoring system 19 may enable operation of a component (e.g., wire feeder, torch) of the welding system 10 when the notification is provided. That is, in some embodiments, the monitoring system 19 may enable the operation of a component of the welding system 10 only when one or more conditions are satisfied and the notification is provided. Additionally, or in the alternative, the monitoring system 19 may stop (e.g., lock out) the operation of a component of the welding system 10 when the one or more monitored environmental conditions does not satisfy a corresponding threshold (i.e., when the notification is provided). In some embodiments, when the monitoring system 19 locks out (e.g., halts, prevents) the operation of a component of the welding system 10 due to one or more unsatisfied conditions, the operator or a supervisor may override the lock out. For example, the operator or a supervisor may provide an input to the monitoring system 19 to acknowledge the one or more unsatisfied conditions prior to operating the component for the process. The monitoring system 19 may record data regarding the override, such as the identity of the operator or supervisor, the time of the override, the overridden threshold, and the monitored condition, among others.

In some embodiments, the feedback device 72 is incorporated with an operator interface 42 of the welding system 10, such as the operator interface 42 of the welding power unit 12, the welding device 14, the gas supply system 16, the welding torch 18, or any combination thereof. That is, the operator interface 42 may provide the notification to the operator as a visual, audible, or haptic feedback. While the monitoring system 19 may be a separate component of the welding system 10, as illustrated in FIG. 1, in some embodiments, the monitoring system 19 is incorporated into a component (e.g., welding power unit 12, welding device 14, gas supply system 16, and so forth) of the welding system 10.

The monitoring system 19 may be coupled to the network 27, which itself may be coupled to a database 74 and/or to a mobile device 76. Additionally, or in the alternative, the monitoring system 19 may be incorporated with the mobile device 76. For example, in certain embodiments, the mobile device 76 may include the processing circuitry 66 and/or the feedback device 72 of the monitoring system 19. In some embodiments, the mobile device 76 communicates directly with the monitoring system 19, the monitoring system 19 communicates with the welding system 10 via a local network, one or more components of the welding system 10 may communicate outside the local network (e.g., with the database 74) via the network 27. The database 74 may be configured to store monitored environmental conditions, thresholds for respective environmental conditions, and welding procedure specifications for various types of welds, among other data related to the welding system 10. The mobile device 76 (e.g., user interface, human-machine interface) may include, but is not limited to, a pager, a cellular phone, a smart phone, a tablet, a laptop, desktop computer, a watch, and so forth. In some embodiments, a welding helmet 78 with a feedback device 72 is coupled to the monitoring system 19 via a wired or wireless connection. Some embodiments of the welding helmet 78 are configured to provide a notification to the operator when an environmental condition satisfies a respective threshold.

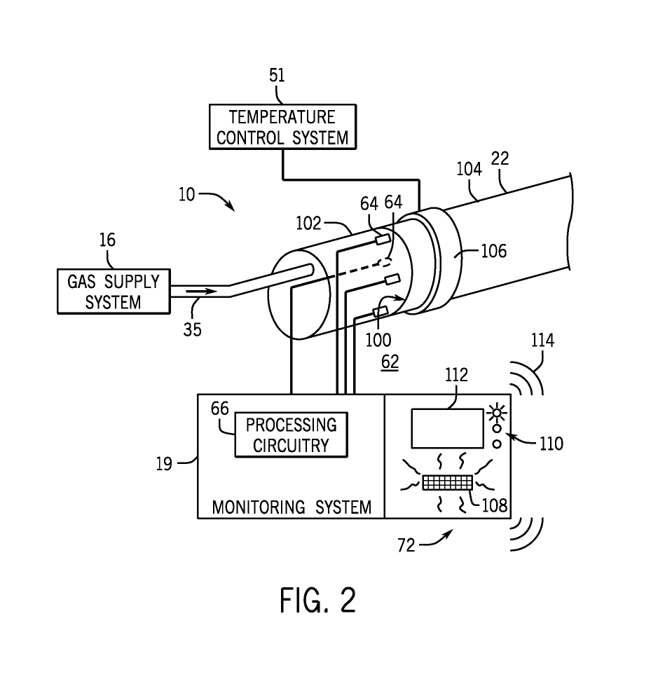

FIG. 2 is an illustration of an embodiment of the monitoring system 19 with sensors 64 configured to provide feedback regarding environmental conditions of the environment 62 about the work piece 22. The work piece 22 includes a joint 100 between a first component 102 (e.g., first pipe section) and a second component 104 (e.g., second pipe section) of the work piece 22. As discussed above, one or more sensors 64 coupled to the monitoring system 19 are disposed in the environment 62 about the joint 100. For example, sensors 64 may be coupled to the work piece 22 proximate to the joint 100, positioned within the work piece 22 (e.g., pipe) proximate to the joint 100, or arranged about the joint 100. An exemplary system designed to couple the sensors 64 to the work piece 22 or to a fixture in the environment 62 is described, for example, in U.S. patent application Ser. No. 14/258,987, filed on Nov. 10, 2013, by Blundell et al., and entitled “Temperature Sensor Belt”, which is hereby incorporated by reference. The sensors 64 provide feedback regarding environmental conditions (e.g., temperature, gas composition, humidity, and so forth) of the environment 62 about the work piece 22 prior to weld formation along the joint 100, during weld formation along the joint 100, after weld formation along the joint 100, or any combination thereof.

The temperature control system 51 may increase or decrease the temperature of the work piece 22 via control of a thermal device 106 coupled to the work piece. The thermal device 106 may be an induction coil and/or a resistive heating coil to add heat to the work piece 22. In some embodiments, the thermal device 106 may circulate a fluid to transfer heat to or from the work piece 22. Accordingly, in some embodiments, the thermal device 106 may cool the work piece 22, such as via circulation of a cooling fluid through the thermal device 106.

The feedback device 72 of the monitoring system 19 may include, but is not limited to, a speaker 108 configured to provide an audible indication (e.g., tone, recorded message, and so forth), one or more lights 110 configured to provide a visual indication (e.g., light turns on, light turns off, light flashes, light changes color, and so forth), or a display 112 configured to provide a visual indication (e.g., graph illustrating sensor history relative to threshold values, numerical representation of values sensed by the sensors 64, textual message, and so forth). Additionally, or in the alternative, the feedback device 72 or a portion thereof may be configured to provide a haptic indication (e.g., vibration), as indicated by the lines 114, such as by an offset motor.

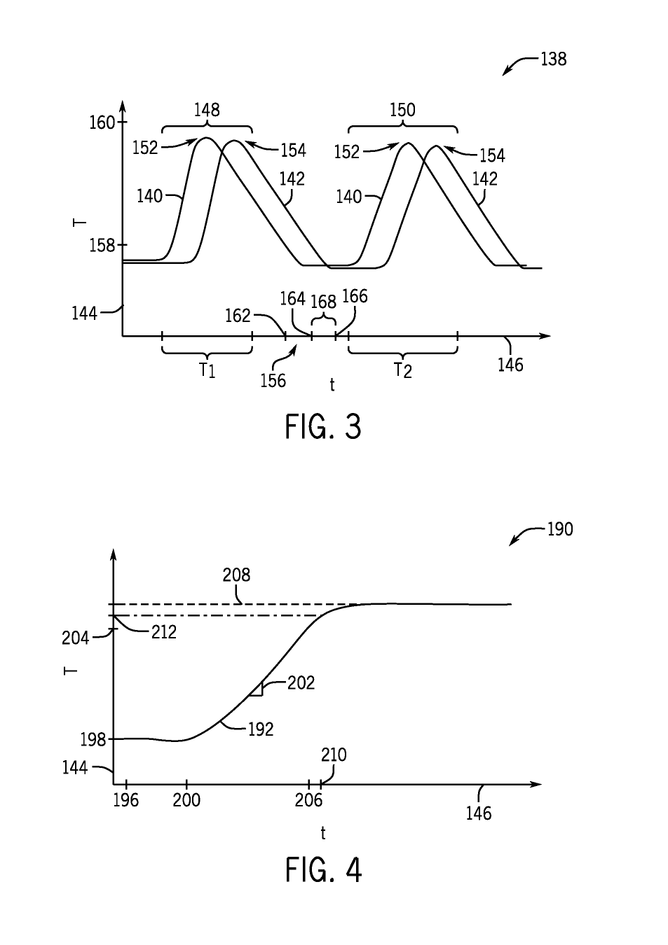

FIG. 3 illustrates a chart 138 of an embodiment of temperature curves 140, 142 of a work piece 22 during a multi-pass welding process. The temperature curves 140, 142 are disposed onto a temperature axis 144 and a time axis 146. In the depicted embodiment, the first temperature curve 140 is related to signals from a first temperature sensor 64, while the second temperature curve 142 is related to signals from a second temperature sensor 64. As illustrated, a first welding pass 148 occurred at a time range T₁, and a second welding pass 150 occurred at a time range T₂. The temperature of the work piece 22 at the location of the first temperature sensor 64 may reach a first peak 152 approximately when the welding torch 18 is nearest to the first temperature sensor 64, and the temperature of the work piece 22 at the location of the second temperature sensor 64 may reach a second peak 154 peak approximately when the welding torch 18 is nearest to the second temperature sensor 64.

After completing the first welding pass 148, the operator may pause before the beginning the second welding pass 150, as indicated by a pause interval 156 between the time ranges T₁ and T₂. The pause interval 156 enables the work piece 22 to cool below a maximum initial temperature threshold 158 prior to beginning the second welding pass 150. The work piece 22 may be actively or passively cooled during the pause interval 156. As may be appreciated, cooling the work piece 22 to or below the maximum initial temperature threshold 158 may enable the first and second peaks 152, 154 to remain below a maximum process temperature threshold 160 during the second welding pass 150. The maximum initial temperature threshold 158 may be stored in the memory 70 of the monitoring system 19. In some embodiments, the maximum initial temperature threshold 158 is based at least in part on a WPS for the welding passes 148, 150. In some embodiments, the monitoring system 19 may disable operation of the welding torch, the welding power unit, or the welding device until the temperature of the work piece 22 is below the maximum initial temperature threshold 158. That is, the monitoring system 19 may enable operation of the welding torch, the welding power unit, or the welding device when providing a notification via the feedback device 72.

The monitoring system 19 described above may provide a notification when one or both of the temperature curves 140, 142 is less than the maximum initial temperature threshold 158. For example, a first notification (e.g., first tone, first light, and so forth) of the monitoring system 19 may notify the operator at a first time 162 when the first curve 140 is less than the maximum initial temperature threshold 158, and a second notification (e.g., second tone, second light) of the monitoring system 19 may notify the operator at a second time 164 when the second curve 142 is less than the maximum initial temperature threshold 158. Additionally, or in the alternative, the monitoring system 19 may provide a notification at a third time 166 when both the first and second temperature curves 140, 142 have been less than the maximum initial temperature threshold 158 for a desired duration of time 168. The notification that a condition (e.g., work piece temperature) satisfies a threshold (e.g., less than the maximum initial temperature threshold 158) enables the operator to reduce the duration of the pause interval 156, thereby decreasing the total time for the operator to complete the first and second weld passes 148, 150.

FIG. 4 illustrates a chart 190 of an embodiment of a temperature curve 192 of a work piece 22 during a pre-heating process. The temperature curve 192 is disposed onto the temperature axis 144 and the time axis 146. As described above, the temperature curve 192 is related signals from a temperature sensor 64. At a time 196 prior to performing a welding process, the work piece 22 may be at approximately a temperature 198 of the ambient environment. The temperature control system 51 may start to preheat the work piece 22 at time 200. In some embodiments, the temperature control system 51 warms the work piece 22 at an approximately uniform rate 202. When the temperature curve 192 is approximately equal to a first control temperature 204 at a first time 206, the temperature control system 51 may decrease the rate at which the heat is provided to the work piece 22, thereby enabling the temperature control system 51 to reduce overshoot of a desired preheat temperature 208. The monitoring system 19 described above may provide a notification at time 210 when the temperature curve 192 is greater than a minimum preheat threshold 212. In some embodiments, the monitoring system 19 may disable operation of the welding torch, the welding power unit, or the welding device until the temperature curve 192 is greater than the minimum preheat threshold 212. The minimum preheat threshold 212 may be stored in the memory 70 of the monitoring system 19. In some embodiments, the minimum preheat threshold 212 is based at least in part on a WPS for the subsequent welding process. Traditionally, the operator manually applied one or more marking indicators to estimate work piece temperature. However, traditional marking indicators do not actively notify a remote operator as the marking indicators are to be visually observed by the operator at the work piece 22.

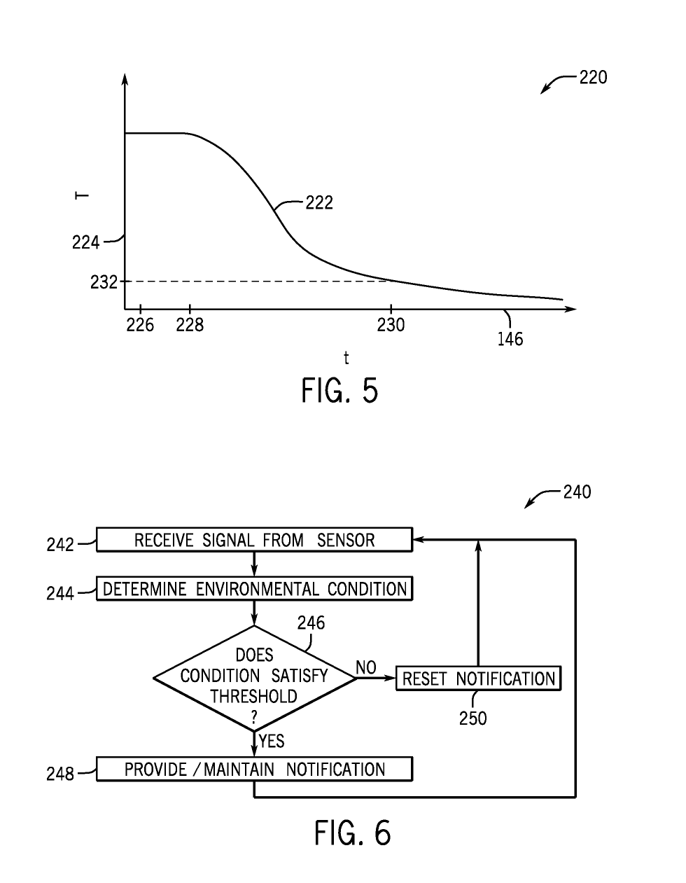

FIG. 5 illustrates a chart 220 of an embodiment of an environmental condition curve 222 of the welding environment 62 about a work piece 22. The environmental condition curve 222 is disposed onto a condition axis 224 and the time axis 146. The environmental condition curve 222 is related to signals from a sensor 64 coupled to the monitoring system 19. In some embodiments, the environmental condition curve 222 is related to a gas composition (e.g., oxygen) of the welding environment 62, a humidity of the welding environment 62, or any combination thereof. In some embodiments, the environmental condition curve 222 is related to a temperature of the welding environment 62. While the discussion below identifies the condition curve 222 as oxygen concentration, the condition curve 222 and notifications based on the condition curve 222 are not to be limited to oxygen concentration of the welding environment 62.

At a time 226 prior to performing a welding process, the oxygen concentration 222 of the welding environment 62 may be approximately the oxygen concentration of ambient environment (e.g., approximately 21%). The gas supply system 16 may provide a shielding gas to the welding environment 62 at a time 228 to reduce the oxygen concentration 222 of the welding environment 62. For example, the gas supply system 16 may provide the shielding gas to an interior of a pipe prior to welding a pipe joint. As discussed above, the shielding gas may include, but is not limited to, argon, helium, carbon dioxide, or any combination thereof. In some embodiments, the shielding gas may reduce the humidity of the welding environment 62. The monitoring system 19 described above may provide a notification at time 230 when the oxygen concentration 222 is less than a maximum concentration threshold 232. Additionally, or in the alternative, the monitoring system 19 may enable operation of the welding torch, the welding device, or the power supply unit when the oxygen concentration 222 is less than the maximum concentration threshold 232. The maximum concentration threshold 232 may be stored in the memory 70 of the monitoring system 19. In some embodiments, the maximum concentration threshold 232 is based at least in part on a WPS for the welding process. As may be appreciated, the oxygen concentration 222 of the welding environment 62 may affect the composition, and therefore the strength, of weld formed therein. Additionally, a WPS may specify the maximum concentration threshold 232 to enable the weld formed by the operator to satisfy design criteria, such as strength, penetration, appearance, and so forth.

The monitoring system 19 enables the active notification of the operator when a condition (e.g., work piece temperature, gas composition) satisfies a threshold (e.g., greater than the minimum preheat threshold 212, less than a maximum concentration threshold 232, and so forth), thereby freeing the operator for non-condition monitoring activities until the condition is satisfied. Additionally, the active notification by the monitoring system 19 enables the operator to reduce an idle duration between when the condition is satisfied and when the operator initiates the subsequent welding process, thereby increasing the efficiency of the operator and the welding system. That is, active notification by the monitoring system 19 may enable the operator to avoid waiting longer than necessary for a changing condition to satisfy a threshold. Moreover, the monitoring system 19 enables a person (e.g., operator, supervisor, technician) remote from the welding environment 62 to be notified when the condition is satisfied.

In some embodiments, the monitoring system 19 may reset or rescind the notification when a condition no longer satisfies the desired threshold. For example, the monitoring system 19 may reset the notification when the temperature curves 140, 142 are no longer less than the maximum initial temperature threshold 158 discussed above with FIG. 3. If the monitoring system 19 notified the operator via turning on a light 110 or initiating a tone from a speaker 108 when the condition satisfied the desired threshold, the monitoring system may turn off the light 110 or stop the tone from the speaker 108 when the condition no longer satisfies the desired threshold. For example, the monitoring system 19 may turn off the light 110 when the first temperature curve 140 exceeds the maximum initial temperature threshold 158, and the monitoring system 19 may stop the tone emitted from the speaker 108 when the temperature curve 192 is less than the minimum preheat threshold 212. Additionally, or in the alternative, if the monitoring system 19 notified the operator via text on a display 112 of the monitoring system 19 that a condition is satisfied, the monitoring system 19 may remove the text from the display 112 when the condition is no longer satisfied. Moreover, if the monitoring system 19 notified the operator via sending a first message (e.g., text message) to a mobile device 72 or to a helmet 78 of the welding system 10 when the condition satisfies the appropriate threshold, the monitoring system 19 may notify the operator via sending a second message to the mobile device 72 or to the helmet 78 to rescind the first message.

As may be appreciated, the monitoring system 19 may record in the memory 70 when conditions are satisfied and when conditions are no longer satisfied. For example, the monitoring system 19 may record the duration that a condition is satisfied (e.g., work piece temperature less than maximum initial temperature threshold 158) between the first welding pass 148 and the second welding pass 150. The duration after a condition is satisfied and before the operator takes a subsequent action is defined herein as an idle duration. Idle durations greater than an acceptable interval may be flagged. The acceptable interval may be defined by the operator, the operator's supervisor, or a system administrator. Flagged idle durations may be tracked to identify operator patterns and/or to evaluate operator efficiency. Moreover, the monitoring system 19 may associate the idle duration with an identity of the operator, a particular welding system, a type of weld, a particular weld of a set of welds for an assembly, or any combination thereof. In some embodiments, the monitoring system 19 determines an efficiency of an operator and/or a welding system based at least in part on the idle durations and durations of other activities performed by the operator and/or welding system over a work period. For example, the monitoring system 19 may determine the efficiency of a welding system as a ratio between the sum of idle durations and a total duration that the welding system is powered during a work period.

FIG. 6 is a flow chart 240 of an embodiment of a process for determining a condition of an environment about the welding system 10. The monitoring system 19 receives (block 242) a signal from a sensor 64 coupled to the monitoring system 19. The sensor 64 may include, but is not limited to a temperature sensor, a gas composition sensor, or any combination thereof. The signal from the sensors 64 is related to a condition of the welding environment 60, such as temperature, gas composition, humidity, and so forth. In some embodiments, the monitoring system 19 receives signals from multiple sensors 64. The monitoring system 19 determines (block 244) the environmental condition related to the received signal. The monitoring system 19 may determine the environmental condition substantially continuously, or at regular intervals, such as approximately every 0.1, 0.5, 1, 5, 15, or 30 seconds or more.

Upon determination of the environmental condition, the monitoring system 19 compares (node 246) the environmental condition to one or more thresholds. The one or more thresholds may be stored in a memory 70 of the monitoring system 19 or a database 74 coupled to the monitoring system 19. As discussed above, the thresholds may include, but are not limited to, a maximum initial temperature threshold, a minimum preheat threshold, and a maximum concentration threshold. Additionally, or in the alternative, the thresholds may include a peak value of an environmental condition, a rate of change (e.g., slope) of an environmental condition, an average value of an environmental condition, an RMS value of an environmental condition. Whether the environmental condition satisfies the threshold depends on the type of threshold. For example, temperatures less than the maximum initial temperature threshold may satisfy the maximum initial temperature threshold, whereas temperatures greater than the minimum preheat threshold may satisfy the minimum preheat threshold. In some embodiments, satisfaction of the threshold is based at least in part on a duration that the environmental condition is greater or less than the appropriate threshold value.

If the determined environmental condition satisfies the threshold, then the monitoring system 19 provides (block 248) a notification. The monitoring system 19 may provide a visual, audible, or haptic notification via the feedback device 72, such as via a light, display, speaker, or vibration control. The notification may be provided to an operator at the welding environment and/or to an operator, supervisor, or technician located remotely, such as via a mobile device 76 or database 74. In some embodiments, the monitoring system 19 may have provided the notification in a previous sample interval, such that the monitoring system 19 maintains (block 248) the notification upon determination that the condition still satisfies the threshold. When the environmental condition satisfies the threshold, the notification enables the operator to perform the welding operation at will. If the determined environmental condition does not satisfy the threshold, then the monitoring system 19 resets (block 250) the notification. That is, if the monitoring system 19 previously provided the notification in the previous sample interval, then the monitoring system 19 resets or rescinds the notification. As discussed above, resetting the notification may include, but is not limited to turning off a light or, stopping a tone, or removing a text notification. Where the monitoring system 19 had not provided the notification in the previous sample interval, the process 240 return to block 242 to receive the signal from the sensor 64 in the next sample interval.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A metal fabrication system comprising:
one or more sensors configured to transmit a first signal relating to a first condition of an environment of the metal fabrication system;
processing circuitry coupled to the one or more sensors, wherein the processing circuitry is configured to determine the first condition of the environment based at least in part on the first signal and to compare the first condition to a first threshold; and
a feedback device coupled to the processing circuitry, wherein the feedback device is configured to provide a first notification when the first condition satisfies the first threshold.

2. The metal fabrication system of claim 1, wherein the first condition comprises a temperature of a work piece of the metal fabrication system.

3. The metal fabrication system of claim 2, comprising a temperature control system configured to heat the work piece, the first threshold comprises a minimum preheat temperature, and the first condition satisfies the first threshold when the temperature of the work piece is greater than the minimum preheat temperature.

4. The metal fabrication system of claim 2, wherein the one or more sensors comprise one or more temperature sensors coupled to a work piece, the first threshold comprises a maximum initial temperature threshold, and the first condition satisfies the first threshold when the temperature of the work piece is less than the maximum initial temperature threshold.

5. The metal fabrication system of claim 1, comprising a gas supply system configured to displace gas in at least a portion of the environment, wherein the first condition comprises a gas concentration of the portion of the environment, the first threshold comprises a maximum concentration threshold of displaced gas in the portion of the environment, and the first condition satisfies the first threshold when the gas concentration of the portion of the environment is less than the maximum concentration threshold.

6. The metal fabrication system of claim 1, wherein the first notification of the feedback device comprises a visual feedback, an audible feedback, a haptic feedback, or any combination thereof.

7. The metal fabrication system of claim 1, wherein the feedback device comprises an operator interface of the metal fabrication system, and the metal fabrication system comprises a power unit, a welding device, a torch, or any combination thereof.

8. The metal fabrication system of claim 1, comprising communications circuitry communicatively coupled to the processing circuitry and to a remote device, wherein the communications circuitry is configured to provide the first notification to the remote device when the first condition satisfies the first threshold.

9. The metal fabrication system of claim 1, wherein the one or more sensors are configured to transmit a second signal relating to a second condition of the environment of the metal fabrication system, the processing circuitry is configured to determine the second condition of the environment related to the second signal, the processing circuitry is configured to compare the second condition to a second threshold, and the feedback device is configured to provide a second notification when the second condition satisfies the second threshold.

10. (canceled)

11. The metal fabrication system of claim 1, wherein the processing circuitry is configured to record a duration between when the feedback device provides the first notification and when an operator of the metal fabrication system performs a metal fabrication process.

12. A method of operating a metal fabrication system, comprising:
receiving, using processing circuitry, a first signal relating to a first condition of an environment of the metal fabrication system;
determining, using the processing circuitry, the first condition of the environment based at least in part on the first signal;
comparing, using the processing circuitry, the first condition to a first threshold; and
providing, using a feedback device, a first notification when the first condition satisfies the first threshold.

13. The method of claim 12, comprising enabling a component of the metal fabrication system to perform a process when providing the first notification, wherein the component comprises a power unit, a torch, or any combination thereof, and the process comprises a shielded metal arc welding (SMAW) process, a gas-metal arc welding (GMAW) process, a tungsten inert gas (TIG) welding process, a laser welding process, a friction stir welding process, a plasma cutting process, a laser cutting process, an oxygen cutting process, a forming process, an induction heating process, or any combination thereof.

14. The method of claim 12, wherein the first condition comprises a temperature of a work piece of the metal fabrication system.

15. The method of claim 12, comprising providing the first notification to a remote device comprising a mobile device, a terminal, a cloud system, a helmet, or any combination thereof.

16. The method of claim 12, comprising determining, using the processing circuitry, a system efficiency based at least in part on a sum of idle durations, wherein each idle duration comprises a duration between when the feedback device provides the first notification and when an operator of the metal fabrication system performs a subsequent process.

17. A welding monitoring system comprising:
one or more temperature sensors configured to determine a first temperature of a work piece of the welding monitoring system;
processing circuitry configured to compare the first temperature to a first temperature threshold; and
a feedback device configured to provide a first notification to an operator of the welding system when the first temperature satisfies the first temperature threshold, wherein the first notification comprises a visual feedback, an audible feedback, a haptic feedback, or any combination thereof.

18. The welding monitoring system of claim 17, wherein the feedback device comprises an operator interface of a welding power unit, a welding device, a welding torch, or any combination thereof.

19. The welding monitoring system of claim 17, wherein the feedback device comprises a mobile device, a terminal, a cloud system, a helmet, or any combination thereof.

20. The welding monitoring system of claim 17, comprising:
communications circuitry communicatively coupled to the processing circuitry and to a network; and
the network, wherein the communications circuitry is configured to provide a first signal to the network when the first temperature satisfies the first temperature threshold and to provide a second signal to the network upon initiation of a welding process subsequent to the provision of the first notification, and the network is configured to record an idle duration between receipt of the first signal and the second signal.
